(19) United States
(12) Patent Application Publication
(10) Pub. No.: US 2013/0022818 A1
(43) Pub. Date: Jan. 24, 2013

(54) ONE-PACK EPOXY RESIN COMPOSITION, AND USE THEREOF

(71) Applicants: Mitsuo Ito, Kikuchi-gun (JP); Tomohiro Fukuhara, Yasu-shi (JP); Osamu Ohtani, Otsu-shi (JP); Seiji Nakajima, Moriyama-shi (JP)

(72) Inventors: Mitsuo Ito, Kikuchi-gun (JP); Tomohiro Fukuhara, Yasu-shi (JP); Osamu Ohtani, Otsu-shi (JP); Seiji Nakajima, Moriyama-shi (JP)

(73) Assignee: OMRON CORPORATION, Kyoto-shi, Kyoto (JP)

(21) Appl. No.: 13/519,328

(22) PCT Filed: Dec. 8, 2010
(86) PCT No.: PCT/JP10/72012

§ 371 Date: Oct. 10, 2012

(30) Foreign Application Priority Data
Jan. 29, 2010 (JP) 2010-018345

(51) Int. Cl. C08L 63/02; B32B 37/12; C08K 5/5415; B32B 27/38; B82Y 30/00

(52) U.S. Cl. 428/414; 523/456; 523/443; 156/330; 977/773

(57) ABSTRACT

Provided are (i) a one-pack epoxy resin which exhibits excellent storage stability in terms of not only composition viscosity but also flowability and (ii) use thereof. The one-pack type epoxy resin composition, contains, as main components, (A) epoxy resin; (B) a modified aliphatic polyamine compound; and (C) inorganic filler treated with a long-chain hydrocarbon-group containing compound. Therefore, the present invention achieves (i) the one-pack type epoxy resin composition which exhibits the excellent storage stability in terms of not only the viscosity but also the flowability and (ii) use thereof.

### TECHNICAL FIELD

The present invention relates to a one-pack type epoxy resin composition and use thereof. In particular, the present invention relates to (i) a one-pack type epoxy resin composition which exhibits excellent storage stability in terms of not only viscosity but also flowability and (ii) use thereof.

### BACKGROUND ART

Epoxy resin is used, for example, as a sealing material, an insulating material, and an adhesive material of electric components and electronic components. In particular, a one-pack type epoxy resin composition in which epoxy resin and a curing agent are mixed in advance has the advantage of easy storage and easy usage over a two-pack epoxy resin composition in which epoxy resin and a curing agent are mixed immediately before use.

The curing agent for use in the one-pack type epoxy resin composition is stored in such a way that the curing agent will not function as a curing agent in a mixture of the curing agent and epoxy resin during the storage. Examples of a method for preventing a curing agent from functioning as a curing agent encompass: a latent curing agent method by use of a latent curing agent which does not function as a curing agent of epoxy resin around room temperature but functions as the curing agent when heated; a method in which a curing agent is enclosed in a microcapsule and is discharged by heating or pressurizing (e.g., see Patent Literature 1); and a method in which a curing agent is capped by use of borate ester.

It is concerned that, when a curing reaction of the one-pack type epoxy resin composition is proceeded while the composition is stored, the one-pack type epoxy resin composition generally increases in viscosity. Accordingly, storage stability of the one-pack type epoxy resin composition is important. The latent curing agent method is effective as a method in which a composition (i) has excellent storage stability and (ii) can be cured for a short time. Examples of the latent curing agent for use in the latent curing agent method encompass dicyandiamide, dibasic acid dihydrazide, boron trifluoride—amine adduct, guanamines, and melamine. However, a solid dispersion-type amine adduct latent curing agent is proposed as a latent curing agent which (i) can be cured with epoxy resin at a lower temperature and (ii) has storage stability in the mixture of the latent curing agent and epoxy resin.

Note, however, that the mixture has a problem in that the mixture of epoxy resin and the latent curing agent does not have enough storage stability and the composition therefore is increased in viscosity while being stored. In order to improve the storage stability, the following methods are presented: a method in which refined crystalline alcohol is mixed with the composition (e.g., see Patent Literature 2); a method in which metal alkoxide is added to the composition (e.g., see Patent Literature 3); and a method in which zeolite and an alkoxide compound are added to the composition (Japanese Patent Application Publication, Tokukaihei, No. 11-310689 A).

### CITATION LIST

Patent Literature 1
Japanese Patent Application Publication, Tokukai, No. 2004-115729 A (Publication date: Apr. 15, 2004)

Patent Literature 2
Japanese Patent Application Publication, Tokukai, No. 2004-277458 A (Publication date: Oct. 7, 2004)

Patent Literature 3
Japanese Patent Application Publication, Tokukaihei, No. 07-196776 A (Publication date: Aug. 1, 1995)

Patent Literature 4
Japanese Patent Application Publication, Tokukaihei, No. 11-310689 A (Publication date: Nov. 9, 1999)

### SUMMARY OF INVENTION

### Technical Problem

A conventional one-pack type epoxy resin composition has been improved in storage stability in terms of increase in viscosity while having been stored, however, the storage stability is not enough even if the increase in viscosity is suppressed.

There has been an increasing demand for miniaturization, light-weight, and high-density of electric and electronic components. As a result, a gap for an adhering part and a gap for a sealing part of an electric or electronic component, such as a small controller, become extremely small. For that reason, it becomes important to control flowability of the one-pack type epoxy resin composition into such gaps.

It has been considered that a one-pack type epoxy resin composition whose viscosity increases during storage of the one-pack type epoxy resin composition has low fluidity, and the low fluidity means that flowability into a movable section etc. is also low. However, the inventors of the present invention found a huge problem that the flowability is increased while the one-pack type epoxy resin composition is stored more than before the composition is stored, and epoxy resin is adhered to a movable section, a contact portion, or the like, thereby causing quality defects of the electric or electronic component.

The present invention has been made in view of the aforementioned problem, and one object of the present invention is to realize (i) a one-pack type epoxy resin composition which exhibits the excellent storage stability in terms of not only viscosity but also flowability and (ii) use thereof.

### Solution to Problem

In order to achieve the aforementioned object, a one-pack type epoxy resin composition according to the present invention contains, as a main component, (A) epoxy resin, (B) a modified aliphatic polyamine compound, and (C) inorganic filler treated with a long-chain hydrocarbon-group containing compound.

According to the aforementioned arrangement, the present invention can realize a one-pack type epoxy resin composition which exhibits excellent storage stability in terms of not only viscosity but also flowability.

### Advantageous Effects of Invention

As described above, a one-pack type epoxy resin composition according to the present invention, contains, as a main component, (A) epoxy resin, (B) a modified aliphatic polyamine compound, and (C) inorganic filler treated with a long-chain hydrocarbon-group containing compound, so that the present invention can realize a one-pack type epoxy resin composition which exhibits the excellent storage stability in terms of not only viscosity but also flowability.

### BRIEF DESCRIPTION OF DRAWINGS

FIG. 1 is a view schematically illustrating a contact portion of an electronic component.

### DESCRIPTION OF EMBODIMENTS

Hereinafter, (I) a one-pack type epoxy resin composition and (II) use of the one-pack type epoxy resin composition of the present invention are described in this order.

(I) One-Pack Type Epoxy Resin Composition

A one-pack type epoxy resin composition according to the present invention contains, as a main components, (A) epoxy resin, (B) a modified aliphatic polyamine compound, and (C) inorganic filler treated with a long-chain hydrocarbon-group containing compound.

According to the aforementioned arrangement, the present invention can realize a one-pack type epoxy resin composition which exhibits excellent storage stability in terms of not only viscosity but also flowability.

The term “storage stability” means stability of a component or a characteristic of the one-pack type epoxy resin composition when the one-pack type epoxy resin composition is stored for a predetermined time period under various environments such as a temperature and a humidity. In particular, it is concerned that the curing reaction of the one-pack type epoxy resin composition is generally proceeded and the viscosity is increased while the composition is stored. Accordingly, only the storage stability in terms of the viscosity has conventionally been problematic.

The inventors of the present invention firstly found that not only the viscosity but also the flowability is increased while the one-pack type epoxy resin composition is stored.

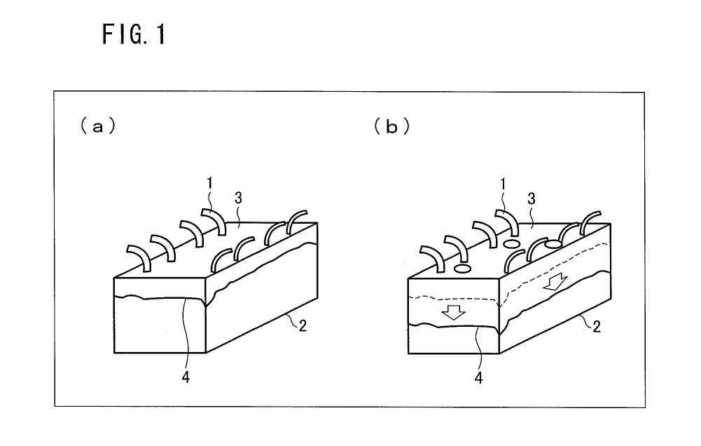

For example, a relay illustrated in FIG. 1 includes (i) a molding material 2 in which a coil, a switch, and the like are received and (ii) a metal terminal 1. An upper surface of the molding material 2 serves as a one-pack type epoxy resin composition application surface 3 on which the one-pack type epoxy resin composition is applied so as to adhere the molding material 2 and the metal terminal 1 to each other. A side surface of the molding material 2 has a narrow gap with respect to another member (not illustrated). The one-pack type epoxy resin composition applied to the one-pack type epoxy resin composition application surface 3 runs into the gap, and is flown downward until the one-pack type epoxy resin composition is completely cured. In the present invention, such property that a one-pack type epoxy resin composition runs into a gap of a contact portion and a gap of a sealing portion, and is flown until the one-pack type epoxy resin composition is completely cured is called “flowability”, and a length from a top end to a bottom end 4 of a trail in which the one-pack type epoxy resin composition is flown, i.e., a flowing-length is used as an index. If the flowability is increased and the epoxy resin is adhered to a movable section, the contact portion, and the like, the epoxy resin adhered thereto causes a huge problem, i.e., quality defects of the electric or electronic component. In order to prevent this problem, fine particles are normally added to the one-pack type epoxy resin composition so as to decrease the flowability of the one-pack type epoxy resin composition.

(a) of FIG. 1 is a view schematically illustrating a state in which a one-pack type epoxy resin composition which is not stored yet is applied. The one-pack type epoxy resin is prepared so as to have (i) low viscosity, (ii) excellent extensity on the one-pack type epoxy resin composition application surface 3 after the one-pack type epoxy resin composition is applied, and (iii) low flowability.

However, as illustrated in (b) of FIG. 1, the viscosity is increased while the composition is stored because the curing reaction proceeds. This causes airtight defects because of a shortage of the extensity. Further, normally, it can be considered that the flowability is decreased when the viscosity is increased. However, as illustrated in (b) of FIG. 1, the inventors of the present invention found that, even in a case where a one-pack type epoxy resin composition to which fine particles are added when the one-pack type epoxy resin composition is prepared is used to reduce flowability, the flowability of the composition is increased when the one-pack type epoxy resin composition is applied after being stored.

The inventors has studied in order to obtain a one-pack type epoxy resin composition which exhibits the excellent storage stability in terms of not only the viscosity but also the flowability. As a result, the inventors found that a one-pack type epoxy resin composition which exhibits the excellent storage stability in terms of not only the viscosity but also the flowability was realized when a specific combination of a curing agent and inorganic filler to be mixed with epoxy resin was formed.

Specifically, the one-pack type epoxy resin composition according to the present invention achieves the aforementioned object by using (B) a modified aliphatic polyamine compound as a curing agent and (C) inorganic filler treated with a long-chain hydrocarbon-group containing compound as inorganic filler.

Note that, in the present invention, the aforementioned “flowing-length” used as an index of the “flowability” indicates values measured by a measuring method described in Examples.

Note that, in the present invention, the reason why (B) a modified aliphatic polyamine compound as a curing agent and (C) inorganic filler treated with a long-chain hydrocarbon-group containing compound as the inorganic filler can achieve the aforementioned object has not proved yet. However, if the flowability is controlled by only thixotropic control which is a conventional control by use of fine particles, the fine particles change over time to thereby cohere to each other while the one-pack type epoxy resin composition is stored, and as a result, the control of the flowability may become difficult. Accordingly, the fine particles have conventionally cohered to each other. However, since the present invention employs the inorganic filler treated with a long-chain hydrocarbon-group containing compound as the inorganic filler, the fine particles less cohere to each other.

The problem of the flowability, which is caused by the change over time during the storage, cannot be solved when the inorganic filler treated with a long-chain hydrocarbon-group containing compound are used and a compound other than (B) a modified aliphatic polyamine compound is used as a curing agent. Accordingly, it can be considered that the one-pack type epoxy resin composition which exhibits the excellent storage stability in terms of the flowability can be obtained by an interaction between (B) a modified aliphatic polyamine compound and (C) inorganic filler treated with a long-chain hydrocarbon-group containing compound.

Furthermore, it is clearly found that the one-pack type epoxy resin composition including (B) a modified aliphatic polyamine compound and (C) inorganic filler treated with a long-chain hydrocarbon-group containing compound is more excellent than a one-pack type epoxy resin composition containing (B) a modified aliphatic polyamine compound and inorganic filler which has been not treated with a long-chain hydrocarbon-group containing compound. From this, it can be considered that, while the composition is stored, (C) the inorganic filler treated with a long-chain hydrocarbon-group containing compound contributes to reduce the curing reaction between epoxy resin and (B) the modified aliphatic polyamine compound. That is, it can be considered that the one-pack type epoxy resin composition which exhibits the excellent storage stability in terms of the viscosity can be obtained by the interaction between (B) the modified aliphatic polyamine compound and (C) the inorganic filler treated with a long-chain hydrocarbon-group containing compound.

The one-pack type epoxy resin composition according to the present invention contains, as main components, at least (A) epoxy resin, (B) a modified aliphatic polyamine compound, and (C) inorganic filler treated with a long-chain hydrocarbon-group containing compound. Specifically, it is preferable that the one-pack type epoxy resin composition according to the present invention consists of (A) epoxy resin, (B) a modified aliphatic polyamine compound, and (C) inorganic filler treated with a long-chain hydrocarbon-group containing compound; however, other components can be contained, provided that the other components do not have a bad effect on the one-pack type epoxy resin composition. More specifically, the wording “as main components” means (A) the epoxy resin, (B) the modified aliphatic polyamine compound, and (C) the inorganic filler treated with a long-chain hydrocarbon-group containing compound preferably account for 70 wt % or more, and more preferably 80 wt % or more. Hereinafter, each component will be described.

(I-1) (A) Epoxy Resin

It is preferable that (A) epoxy resin contained in the one-pack type epoxy resin composition of the present invention is epoxy resin which becomes fluid around room temperature (e.g., 25° C.). As such epoxy resin, various epoxy resins of conventionally known one-pack type epoxy resin compositions can be used. Examples of the epoxy resin encompass a compound in which an aromatic ring (such as a benzene ring and a naphthalene ring) or a hydrogenerated aromatic ring (such as a hydrogenerated benzene ring) is bonded with two or more epoxy groups at a terminal of the compound.

The aromatic ring and the hydrogenerated aromatic ring may be bonded with a substituent such as alkyl or halogen. Further, (i) these epoxy groups and (ii) the aromatic ring or the hydrogenerated aromatic ring can be bonded via oxyalkylene, poly(oxyalkylene), carboxyalkylene, carbopoly(oxyalkylene), aminoalkylene, or the like.

Furthermore, in a case where there are a plurality of aromatic rings and/or hydrogenerated aromatic rings, these aromatic rings and/or hydrogenerated aromatic rings may be directly bonded with each other, or may be bonded with each other via an alkylene group, an oxyalkylene group, a poly(oxyalkylene) group, or the like.

Specifically, examples of the fluid epoxy resin encompass bisphenol-A diglycidyl ether, bisphenol-F diglycidyl ether, bisphenol-A ethylene oxide 2-mol adduct diglycidylether, bisphenol-A-1,2-propylene oxide 2-mol adduct diglycidylether, hydrogenerated bisphenol-A diglycidyl ether, hydrogenerated bisphenol-F diglycidyl ether, orthophthalic acid diglycidylester, tetrahydroisophthalic acid diglycidylester, N,N-diglycidylaniline, N,N-diglycidyltoluidine, N,N-diglycidylaniline-3-glycidylether, tetraglycidylmetaxylenediamine, 1,3-bis(N,N-diglycidylaminomethylene)cyclohexane, and tetrabromobisphenol-A diglycidylether. The fluid epoxy resin can be used alone, and two or more kinds of fluid epoxy resin can be also used in combination.

Among them, it is more preferable to use, as the fluid epoxy resin, bisphenol-A diglycidyl ether, hydrogenerated bisphenol-A diglycidyl ether, bisphenol-F diglycidyl ether, and/or hydrogenerated bisphenol-F diglycidyl ether, in view of superiority in heat resistance of cured epoxy resin composition.

Content of epoxy resin in the one-pack type epoxy resin composition can be changed appropriately, and for example, epoxy resin having 50 wt % or more but 95 wt % or less can be used.

(I-2) (B) Modified Aliphatic Polyamine Compound

It is preferable that (i) a modified aliphatic polyamine compound contained in the one-pack type epoxy resin composition of the present invention is stable around room temperature in a mixture of the modified aliphatic polyamine compound and epoxy resin and (ii) the modified aliphatic polyamine compound functions as a curing agent which is formed into a cured epoxy resin composition which indicates a high heat deflection temperature by being subjected to a thermal treatment at a temperature of 80° C. or more but 120° C. or less. It is also preferable that the modified aliphatic polyamine compound is a solid insoluble with a liquid general epoxy resin around room temperature, however, exhibits an original function when being heated and dissolved.

The modified aliphatic polyamine compound only needs to be a reaction product obtained by reacting at least an amine compound and an isocyanate compound with each other. A compound called “aliphatic polyamine modification product” are generally included in the modified aliphatic polyamine compound.

More specifically, for example, the modified aliphatic polyamine compound may be a reaction product obtained by reacting (i) a dialkylaminoalkylamine compound, (ii) a cyclic amine compound containing, in a molecule, one or more nitrogen atoms each having an active hydrogen, and (iii) a diisocyanate compound.

Further, the modified aliphatic polyamine compound may be a reaction product obtained by reacting the three components ((i), (ii), and (iii)) with (iv) an epoxy compound serving as a fourth component.

The following reaction products are more preferably used as the modified aliphatic polyamine compound: a reaction product made from (i) a dialkylaminoalkylamine compound, (ii) a cyclic amine compound containing, in a molecule, one or two nitrogen atoms each having an active hydrogen, and (iii) a diisocyanate compound, which reaction product is obtained by thermally reacting those three components with each other; and a reaction product made from (i) a dialkylaminoalkylamine compound, (ii) a cyclic amine compound containing, in a molecule, one or two nitrogen atoms each having an active hydrogen, (iii) a diisocyanate compound, and (iv) an epoxy compound having one or more epoxy groups per molecule on average, which reaction product is obtained by thermally reacting those four components with each other.

Furthermore, examples of the modified aliphatic polyamine compound encompass compounds disclosed in Japanese Examined Patent Application Publication, Tokukosho, No. 58-55970 B, Japanese Patent Application Publication, Tokukaisho, No. 59-27914 A, Japanese Patent Application Publication, Tokukaisho, No. 59-59720 A, and Japanese Patent Application Publication, Tokukaihei, No. 3-296525A.

Here, (i) the dialkylaminoalkylamine compound is not particularly limited.

For example, it is preferably to use, as the dialkylaminoalkylamine compound, a compound having a structure represented by the following Chemical Formula (I):

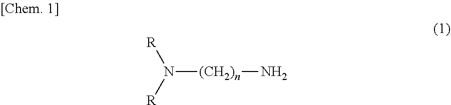

(where: “R” independently represents a C1 to C4 linear or branched alkyl group; and “n” represents 2 or 3).

Specific examples of (i) the dialkylaminoalkylamine compound encompass dimethylaminopropylamine, diethylaminopropylamine, dipropylaminopropylamine, dibutylaminopropylamine, and dimethylaminoethylamine, diethylaminoethylamine, dibutylaminoethylamine. Among them, it is particularly preferable that (i) the dialkylaminoalkylamine compound is dimethylaminepropylamine or diethylaminopropylamine. (i) Dialkylaminoalkylamine compound can be used alone, and two or more kinds of dialkylaminoalkylamine compounds can be used in combination.

Further, (ii) the cyclic amine compound containing, in a molecule, one or more nitrogen atoms each having an active hydrogen is not particularly limited. Examples of the cyclic amine compound encompass polyamines and monoamines such as meta-xylylenediamine, 1,3-bis(aminomethyl)cyclohexane, isophoronediamine, diaminocyclohexane, phenylenediamine, toluoylenediamine, piperazine, N-aminoethylpiperazine, benzylamine, and cyclohexylamine. Among them, it is particularly preferable to use, as the cyclic amine compound, meta-xylylenediamine, 1,3-bis(aminomethyl)cyclohexane, isophoronediamine, N-aminoethylpiperazine, cyclohexylamine, and/or benzylamine. Among those amine components, the polyamines function as a molecular chain growth material and as a curing agent compound, meanwhile, the monoamines function as a molecule-weight adjusting material. (ii) The cyclic amine compound containing one or more nitrogen atoms each having an active hydrogen can be used alone, and two or more kinds of cyclic amine compounds can be used in combination.

(iii) The diisocyanate is not particularly limited. Examples of the diisocyanate encompass isophorone diisocyanate, meta-xylylene diisocyanate, 1,3-bis(isocyanatomethyl)cyclohexane, 2,4-toluoylene diisocyanate, 2,6-toluoylene diisocyanate, 1,5-naphthylene diisocyanate, 1,4-phenylene diisocyanate, diphenylmethane-4,4′-diisocyanate, 2,2′-dimethyldiphenylmethane-4,4′-diisocyanate, hexamethylene diisocyanate, and trimethyl hexamethylene diisocyanate. Among them, it is particularly preferable that (iii) the diisocyanate is diisocyanate having a ring structure. (iii) The diisocyanate can be used alone, and two or more kinds of the diisocyanate can be used in combination.

(iv) The epoxy compound is not particularly limited. Examples of the epoxy compound encompass: glycidyl ether obtained by reacting epichlorohydrin with polyhydric phenol (such as bisphenol-A, bisphenol-F, bisphenol-S, hexahydrobisphenol-A, tetramethylbisphenol-A, catechol, resorcin, cresol novolac, tetrabromobisphenol-A, trihydroxybiphenyl, bisresorcinol, bisphenol-hexafluoroacetone, hydroquinone, tetramethylbisphenol-A, tetramethylbisphenol-F, triphenylmethane, tetraphenylethane, and bixylenol); polyglycidyl ether obtained by reacting epichlorohydrin with aliphatic polyalcohol (such as glycerin, neopentylglycol, ethylene glycol, propylene glycol, butylene glycol, hexylene glycol, polyethylene glycol, and polypropylene glycol); glycidyl ether ester obtained by reacting a hydroxy carboxylic acid (such as a p-hydroxy benzoic acid and a β-hydroxynaphthoic acid) with epichlorohydrin; polyglycidyl ester obtained from a polycarboxylic acid (such as a phthalic acid, a methylphthalic acid, isophthalic acid, terephthalic acid, tetrahydrophthalic acid, hexahydrophthalic acid, endo methylene hexahydrophthalic acid, trimellitic acid, polymerized fatty acid; glycidyl amino glycidyl ether obtained from aminophenol, aminoalkylphenol, and the like; glycidyl amino glycidyl ester obtained from an aminobenzoic acid; glycidylamine obtained from aniline, toluidine, tribromoaniline, xylylenediamine, diaminocyclohexane, bis(aminomethyl)cyclohexane, 4,4′-diamino diphenylmethane, 4,4′-diaminodiphenyl sulfone, and the like; epoxidized polyolefin; glycidyl hydantoin; glycidyl alkyl hydantoin; triglycidyl cyanurate; and monoepoxide (such as butyl glycidyl ether, phenyl glycidyl ether, alkyl phenyl glycidyl ether, benzoic acid glycidyl ester, and styrene oxide).

(iv) The epoxy compound can be used alone, and two or more kinds of epoxy compounds can be used in combination.

It is more preferable that polyepoxide containing a plurality of epoxy groups in a molecule and monoepoxide containing one epoxy group in a molecule are used, as (iv) the epoxy compound, in combination.

It is particularly preferable to use, as the polyepoxide, diepoxide such as bisphenol-A type diepoxide (epoxy equivalent of about 190), bisphenol-F type diepoxide (epoxy equivalent of about 175), diglycidylaniline, diglycidyl ortho-toluidine, or the like. Further, it is particularly preferable to use, as the monoepoxide, phenyl glycidyl ether, methylphenyl glycidyl ether, butylphenyl glycidyl ether, or the like. Among the aforementioned epoxide, polyepoxide (in particular, diepoxide) functions as a molecular chain growth material, and monoepoxide functions as a molecule-weight adjusting material.

It is also preferable to use, as the modified aliphatic polyamine compound, modified aliphatic polyamine compounds which are general commercially-available products, and such commercially available products are not particularly limited. Examples of the commercially available products encompass FUJICURE FXE-1000, FXR-1030, and FXB-1050 (manufactured by Fuji Kasei Kogyo Co.).

(I-3) (C) Inorganic filler treated with a long-chain hydrocarbon-group containing compound

(C) The inorganic filler treated with a long-chain hydrocarbon-group containing compound contained in the one-pack type epoxy resin composition of the present invention is subjected to a surface treatment by use of a long-chain hydrocarbon-group containing compound.

The inorganic filler to be subjected to the surface treatment is not particularly limited. For example, it is preferable to use dissolved silica, crystalline silica, talc, alumina, silicon nitride, calcium carbonate, calcium silicate, and/or the like. The inorganic filler can be used alone, and two or more kinds of inorganic filler can be used in combination. In a case where two or more kinds of inorganic filler are used, the inorganic filler can be arbitrarily used at an arbitrary ratio. Among them, the inorganic filler to be subjected to the surface treatment is more preferably silica and calcium carbonate because silica and calcium carbonate are superior to others in thermal expansion and thermal conduction.

Form of the inorganic filler to be subjected to the surface treatment is not particularly limited, provided that the inorganic filler is particles whose shape is spherical, granular, acicular, or tabular, for example. It is more preferable that the shape of the particles is spherical or granulated.

Further, a particle diameter of the each inorganic filler to be subjected to the surface treatment can be appropriately adjusted so that the particle diameter of the inorganic filler after the surface treatment would fall within a range described below. Specifically, an average particle diameter of the inorganic filler to be subjected to the surface treatment is preferably 10 nm or more but 100 nm or less. Note that a method for adjusting the average particle diameter of the inorganic filler is not particularly limited, and a conventional well-known method can be appropriately used. For example, an average particle diameter of silica which is the inorganic filler can be adjusted by using the following method. Specifically, the inorganic filler is hydrolyzed (or is oxidatively decomposited) at a temperature of 1000° C. to 1200° C. in high-temperature oxyhydrogen flame (or while the inorganic filler is indirectly heated in oxygen atmosphere), then an aggregate having a soot-like loose combination is formed once. After that, the aggregate is heated at a temperature of 1800° C. or more and is melted. Then the aggregate is cooled and recombined in a random manner. Further, an average particle diameter of calcium carbonate can be adjusted by grinding/classification of calcium carbonate.

The inorganic filler only needs to be subjected to the surface treatment by use of the long-chain hydrocarbon-group containing compound. Herein, a method for carrying out the surface treatment by use of the long-chain hydrocarbon-group containing compound is not limited, provided that a long-chain hydrocarbon group derived from the long-chain hydrocarbon-group containing compound is treated so as to be directly or indirectly bonded with a surface of the inorganic filler. Further, how the long-chain hydrocarbon group is bonded with the surface is not particularly limited, and the long-chain hydrocarbon group and the surface may be bonded with each other by a covalent bond, a coordinate bond, a hydrogen bond, or the like.

The surface treatment makes it possible to improve (i) dispersibility of the inorganic filler to the one-pack type epoxy resin composition and (ii) cohesiveness between the one-pack type epoxy resin composition and the inorganic filler. As a result, by using the inorganic filler subjected to the surface treatment, it is possible to effectively control the flowability of the one-pack type epoxy resin composition after the one-pack type epoxy resin composition is stored and is changed over time.

It is preferable that the long-chain hydrocarbon-group containing compound for use in the surface treatment is a compound which contains a hydrocarbon group having a main chain of C8 or more but C20 or less. It is because using C8 or more of the main chain of the hydrocarbon group can improve the storage stability in terms of the flowability and can exhibit enough large thixotropy effect. Further, since the main chain of the hydrocarbon group has C20 or less, it is therefore possible to exhibit the thixotropy effect corresponding to an additive amount of the long-chain hydrocarbon-group containing compound. This makes it possible not only to reduce the cost increase caused by excessive addition of the long-chain hydrocarbon-group containing compound but also to exhibit an enough thixotropy effect.

The hydrocarbon group is not particularly limited, and both a saturated hydrocarbon group and an unsaturated hydrocarbon group can be used. For example, an alkyl group or an alkenyl group can be preferably used. Accordingly, examples of the long-chain hydrocarbon-group containing compound encompass a long-chain alkyl group containing compound and a long-chain alkenyl group containing compound. Further, the number of carbon-carbon double bonds of alkenyl group is also not particularly limited, however, one or more but five or less of carbon-carbon double bonds are more preferable.

More specifically, it is more preferable that the hydrocarbon group is included in, for example, a palmitoyl group, a stearyl group, a decyl group, a fatty acid (described below), and a long-chain alkylsilane compound.

The method for carrying out the surface treatment is not particularly limited, and, for example, the surface treatment is carried out by heating the long-chain hydrocarbon-group containing compound at a temperature of 200° C. or more in a state in which the long-chain hydrocarbon-group containing compound is provided on the surface of the inorganic filler. The heating promotes a binding reaction between the long-chain hydrocarbon-group containing compound and the surface of the inorganic filler. The heating temperature only needs to be 200° C. or more, however, 200° C. or more and 400° C. or less is more preferable.

Examples of a method for providing the long-chain hydrocarbon-group containing compound on the surface of the inorganic filler encompass: a method for spraying a long-chain hydrocarbon-group containing compound into inorganic filler; and a method for dipping inorganic filler into a solution of a long-chain hydrocarbon-group containing compound, and any method can be appropriately used. Further, it is more preferable to carry out the surface treatment under nitrogen atmosphere. A solvent for use in preparation for the solution of the long-chain hydrocarbon-group containing compound is not particularly limited, and any solvent can be appropriately selected in accordance with a long-chain hydrocarbon-group containing compound to be used.

As the long-chain alkyl group containing compound, for example, a saturated fatty acid which is generally used as a surface treatment agent can be preferably used. The saturated fatty acid is not particularly limited, and examples of the saturated fatty acid encompass a decanoic acid (capric acid), an undecanoic acid, a dodecanoic acid (lauric acid), tridecanoic acid, a tetradecanoic acid (myristic acid), pentadecanoic acid, a hexadecanoic acid (palmitic acid), a heptadecanoic acid (margaric acid), an octadecanoic acid (stearic acid), a nonadecanoic acid (tuberculostearic acid), a icosanoic acid (arachidic acid), and a docosanoic acid (behenic acid). Among them, it is particularly preferable to use, as the saturated fatty acid, a lauric acid, a myristic acid, a palmitic acid, and a stearic acid.

Further, the long-chain alkenyl group containing compound, for example, an unsaturated fatty acid which is generally used as the surface treatment agent can be preferably used. The examples of the unsaturated fatty acid encompass a palmitoleic acid, an oleic acid, an elaidic acid, a vaccenic acid, a gadoleic acid, an eicosenoic acid, a linoleic acid, an eicosadienoic acid, a linolenic acid, a pinolenic acid, an eleostearic acid, a mead acid, an eicosatrienoic acid, a stearidonic acid, an arachidonic acid, an eicosatetraenoic acid, a bosseopentaenoic acid, and an eicosapentaenoic acid. Among them, it is particularly preferable to use an oleic acid and a linoleic acid as the unsaturated fatty acid.

Further, it is also preferable to use, as the long-chain alkyl group containing compound, a long-chain alkylsilane type alkyl group containing compound such as dodecyltrimethoxysilane, hexadecyltrimethoxysilane, and octadecyltrimethoxysilane. Among them, it is particularly preferable to use, as the long-chain alkylsilane alkyl group containing compound, hexadecyltrimethoxysilane and octadecyltrimethoxysilane.

Form of (C) the inorganic filler treated with a long-chain hydrocarbon-group containing compound is not particularly limited, provided that the inorganic filler is particles whose shape is spherical, granular, acicular, or tabular. It is more preferable that the shape of the particles is spherical or granular, for example.

Further, it is possible to reduce the flowability of the one-pack type epoxy resin composition if the inorganic filler treated with a long-chain hydrocarbon-group containing compound have a normal average particle diameter. However, it is more preferable that the average particle diameter is 10 nm or more but 100 nm or less, and more preferably 10 nm or more but 50 nm or less. Since the average particle diameter of the inorganic filler treated with the long-chain hydrocarbon-group containing compound is 10 nm or more but 100 nm or less, a small amount of the inorganic filler is mixed with the one-pack type epoxy resin composition, and it is therefore possible to reduce the flowability of the one-pack type epoxy resin composition. Further, since the average particle diameter of the inorganic filler treated with the long-chain hydrocarbon-group containing compound is 10 nm or more, the inorganic filler is mixed with the one-pack type epoxy resin composition, and it is therefore possible to prevent increase in viscosity. This makes it possible to prevent reduction in workability. Further, since the average particle diameter of the inorganic filler treated with the long-chain hydrocarbon-group containing compound is 100 nm or less, a small amount of the inorganic filler is mixed with the one-pack type epoxy resin composition, and it is therefore possible to control the flowability to a narrow gap.

Note that, in this specification, an average particle diameter of particles is a value calculated on the basis of a value measured by use of a particle size distribution measuring device (Trade Name: LA920, manufactured by HORIBA, Ltd.) based on a laser diffraction/scattering method (D50). Specifically, an average particle diameter is calculated for each peak in a particle diameter distribution thus measured, and an average particle diameter of a peak having the most high content ratio is determined as an “average particle diameter”.

Note that a content ratio of each peak is determined on the basis of an area of a frequency distribution ratio. Here, in a case where a plurality of peaks are overlapped with each other, it is possible to use a method for fitting the each peak by use of an appropriate function (Lorentz function or Gaussian function), and subtracting an optimal ratio from each peak. More specifically, it is possible to calculate the content ratio of each peak by use of accompanying software of the particle size distribution measuring device or general spreadsheet software (Excel, IGOR, Mathmatica, etc. (all of them is trade name)).

(I-4) Content of Each Component

A content ratio of (A) epoxy resin, (B) a modified aliphatic polyamine compound, and (C) inorganic filler treated with a long-chain hydrocarbon-group containing compound is not particularly limited, provided that the one-pack type epoxy resin composition according to the present invention contains, as main components, (A) epoxy resin, (B) a modified aliphatic polyamine compound, and (C) inorganic filler treated with a long-chain hydrocarbon-group containing compound. It is more preferable that, in a case where a content of (A) the epoxy resin is assumed to be 100 parts by weight, a content of (B) the modified aliphatic polyamine compound and a content of (C) the inorganic filler is 7 parts by weight or more but 25 parts by weight or less in total. When the content of (A) the epoxy resin is 100 parts by weight, and a sum total of the content of (B) the modified aliphatic polyamine compound and the content of (C) the inorganic filler falls within the aforementioned range, the present invention can achieve the one-pack type epoxy resin composition which exhibits the excellent storage stability in terms of the viscosity and the flowability.

Further, a ratio of the content of (B) the modified aliphatic polyamine compound to the content of (C) the inorganic filler is not particularly limited. However, it is more preferable that the content of (C) the inorganic filler/the content of (B) the modified aliphatic polyamine compound is 0.025 or more but 1.000 or less. When the content of (C) the inorganic filler/the content of (B) the modified aliphatic polyamine compound falls within the aforementioned range, the present invention can achieve the one-pack type epoxy resin composition which exhibits the excellent storage stability in terms of viscosity and flowability.

Further, in the one-pack type epoxy resin composition according to the present invention, it is most preferable that (i) a sum total of the content of (B) the modified aliphatic polyamine compound and the content of (C) the inorganic filler falls within the aforementioned range, and (ii) the content of (C) the inorganic filler/the content of (B) the modified aliphatic polyamine compound falls within the range of the aforementioned range.

(I-5) Other Components

Other components can be contained in the one-pack type epoxy resin composition according to the present invention, provided that (i) the one-pack type epoxy resin composition contains, as main components, (A) epoxy resin, (B) a modified aliphatic polyamine compound, and (C) inorganic filler treated with a long-chain hydrocarbon-group containing compound and (ii) the other components do not have a bad effect on the present invention.

Examples of the other components encompass various additives for use in a conventionally well-known epoxy resin composition such as a flame retarding agent, a photostabilizer, a viscosity modifier, a colorant, a reinforcing agent, a thickener, and a thixotropic agent.

(I-6) Method for manufacturing one-pack type epoxy resin composition according to the present invention

A method for manufacturing the one-pack type epoxy resin composition is not particularly limited, and a general method for manufacturing a one-pack type epoxy resin composition can be appropriately used, provided that the one-pack type epoxy resin composition according to the present invention contains, as main components, (A) epoxy resin, (B) a modified aliphatic polyamine compound, and (C) inorganic filler treated with a long-chain hydrocarbon-group containing compound. Such method is, for example, a method for mixing or stirring (A) epoxy resin, (B) a modified aliphatic polyamine compound, and (C) inorganic filler treated with a long-chain hydrocarbon-group containing compound by use of a conventionally well-known device such as a kneader or a mixing roll.

(II) Use of One-Pack Type Epoxy Resin Composition According to the Present Invention

The one-pack type epoxy resin composition according to the present invention exhibits the excellent storage stability in terms of not only viscosity but also flowability. The one-pack type epoxy resin composition can be applied to (i) components (such as an electronic component and an electric component and (ii) a method for sealing the electronic or electric component. Therefore, the components and the method for sealing those components are included within the scope of the present invention.

(II-1) Electronic Component and Electric Component

A component according to the present invention is an electronic or an electric component, and at least two members are adhered to each other by the one-pack type epoxy resin composition.

The electronic or electric component is not particularly limited, provided that the electronic or electric component is useful for performing airtight sealing or insulating sealing on the electronic or electric component. That is, a component normally called “electric component” can be used. Examples of the electronic or electric component encompass a relay, a switch, and a sensor.

Note that the wording “at least two members are adhered to each other by the one-pack type epoxy resin composition” means the one-pack type epoxy resin composition is inserted between the at least two members and the at least two members are combined with each other by adhesion of the one-pack type epoxy resin composition.

Further, an object to be adhered is not particularly limited. For example, a molding material and a metal terminal of the relay are adhered to each other by the one-pack type epoxy resin composition.

(II-2) Sealing Method

A sealing method according to the present invention, includes at least the step of sealing an electronic or electric component by adhering at least two members to each other by use of the aforementioned one-pack type epoxy resin composition.

The step is similar to a conventionally well-known method, except that the step employs the aforementioned one-pack type epoxy resin composition.

A method for adhering members to each other by use of the one-pack type epoxy resin composition may be carried out, for example, in such a manner that: the one-pack type epoxy resin composition is applied to at least a part of or a whole one component; a member to be adhered to the one component is adhered to the one component; and the one-pack type epoxy resin composition is cured.

That is, the present application includes the following inventions.

In order to attain the aforementioned object, a one-pack type epoxy resin composition according to the present invention contains, as main components, (A) epoxy resin, (B) a modified aliphatic polyamine compound, and (C) an inorganic filler treated with a long-chain hydrocarbon-group containing compound.

According to the aforementioned arrangement, the present invention achieves the one-pack type epoxy resin composition which exhibits the excellent storage stability in terms of not only composition viscosity but also flowability.

In the one-pack type epoxy resin composition according to the present invention, it is more preferable that, in a case where a content of the (A) epoxy resin is 100 parts by weight, (i) a sum total of the content of (B) the modified aliphatic polyamine compound and the content of (C) the inorganic filler treated with a long-chain hydrocarbon-group containing compound is 7 parts by weight or more but 25 parts by weight or less and (ii) the content of (C) the inorganic filler treated with a long-chain hydrocarbon-group containing compound/the content of (B) the modified aliphatic polyamine compound is 0.025 or more but 1.000 or less.

According to the aforementioned arrangement, the present invention attains the one-pack type epoxy resin composition which exhibits more excellent storage stability in terms of the viscosity and the flowability.

In the one-pack type epoxy resin composition according to the present invention, the inorganic filler treated with the long-chain hydrocarbon-group containing compound has a hydrocarbon group having a main chain of C8 or more but C20 or less.

According to the aforementioned arrangement, the present invention attains the one-pack type epoxy resin composition which exhibits more excellent storage stability in terms of not only composition viscosity but also flowability.

In the one-pack type epoxy resin composition according to the present invention, it is more preferable that an average particle diameter of the inorganic filler treated with the long-chain hydrocarbon-group containing compound is 10 nm or more but 50 nm or less.

According to the aforementioned arrangement, the present invention attains the one-pack type epoxy resin composition which exhibits furthermore excellent storage stability in terms of the flowability.

In a component according to the present invention, at least two members are adhered to each other by use of the one-pack type epoxy resin composition.

According to the aforementioned arrangement, it is possible to produce a component (i) in which airtight defects due to increase in viscosity can be reduced while the one-pack type epoxy resin composition is stored irrelevant to how long the one-pack type epoxy resin composition is stored and (ii) which does not have such a problem that the flowability is increased while the one-pack type epoxy resin composition is stored.

A sealing method according to the present invention includes the steps of sealing an electronic or electric component by adhering at least two members to each other by use of the one-pack type epoxy resin composition.

According to the aforementioned arrangement, it is possible to seal an electronic or electric component (i) in which airtight defects due to increase in viscosity can be reduced while the one-pack type epoxy resin composition is stored irrelevant to how long the one-pack type epoxy resin composition is stored and (ii) which does not have such a problem that the flowability is increased.

### EXAMPLES

Hereinafter, the present invention will be described in detail on the basis of Examples, however, the present invention is not limited to the following Examples.

Storage stability evaluation examination for evaluating viscosity and a flowing-length of a one-pack type epoxy resin composition thus obtained was measured by use of the below-mentioned method.

<Storage Stability Evaluation Examination for Viscosity>

A one-pack type epoxy resin composition immediately after preparation was measured by a rotation viscometer (E-type viscometer, RE215-type; manufactured by TOKI SANGYO CO., LTD.), and the viscosity thus measured was set as “initial viscosity”. The one-pack type epoxy resin composition was stored for a month in a thermostatic oven at a predetermined temperature (40° C.), and after that, viscosity of the one-pack type epoxy resin composition was measured in the same way as the initial viscosity. Thus a rate of change from the initial viscosity to the viscosity was evaluated. The rate of change less than 150% was represented by “excellent”, the rate of change of 150% or more and 200% or less was “good”, and the rate of change of 200% or more was represented as “poor”.

<Storage Stability Evaluation Examination of Flowing-Length>

A B270-glass (white plate glass, manufactured by MATSUNAMI GLASS IND., LTD.) having a size of 26 mm×76 mm×0.9 mm was perpendicularly fixed to a fixture. The one-pack type epoxy resin composition (about 30 mg) immediately after preparation was dropped on an upper part of the glass plate by use of a dispenser, and then the glass plate was heated for an hour in an oven at a temperature of 100° C. A length of a trail from an upper end (in which the one-pack type epoxy resin composition started to be flown) to a lower end (in which the one-pack type epoxy resin composition finished to be flown) of the one-pack type epoxy resin composition was measured by a vernier caliper, and the length was represented as an “initial flowing-length”. The one-pack type epoxy resin composition was stored for a month in a thermostatic oven at a predetermined temperature (40° C.), and after that, a flowing-length of the one-pack type epoxy resin composition was measured in the same way as the initial flowing-length. Thus a rate of change from the initial flowing-length to the flowing-length was evaluated. The rate of change less than 150% was represented by “excellent”, the rate of change of 150% or more and 200% or less was “good”, and the rate of change of 200% or more was represented as “poor”.

### Example 1

Bisphenol-A diglycidyl ether was used as epoxy resin, and a modified aliphatic polyamine compound of 20 parts by weight (Trade Name: FUJICURE FXE-1000, manufactured by Fuji Kasei Kogyo Co.) was added to the bisphenol-A diglycidyl ether of 100 parts by weight. Then, as the inorganic filler treated with a long-chain hydrocarbon-group containing compound silica (0.5 part by weight) having an average particle diameter of 10 nm to 50 nm, which silica is treated with a compound containing long-chain hydrocarbon group having a main chain of C8 to C20, was mixed with this mixture. After that, this mixture was kneaded by use of a mixing roll, and the one-pack type epoxy resin composition was thus prepared. Note that the inorganic filler treated with a long-chain hydrocarbon-group containing compound are obtained by spraying, to the silica, a solution of octadecyltriethoxysilane and diethylamine (catalyst) dissolved in hexane (solvent) and then heating the silica at a temperature of 200° C.

The storage stability evaluation examination was performed on the one-pack type epoxy resin composition thus obtained in terms of the viscosity and the flowing-length.

The contents of the respective components of the one-pack type epoxy resin composition, a sum total of a content of a modified aliphatic polyamine compound and a content of inorganic filler treated with a long-chain hydrocarbon-group containing compound (in Table 1, referred to as a “sum total of contents of curing agent and inorganic filler”), the content of the inorganic filler treated with a long-chain hydrocarbon-group containing compound/the content of the modified aliphatic polyamine compound (in Table 1, referred to as “(content of inorganic filler)/(content of curing agent)”), a result of the viscosity by the storage stability evaluation examination (in Table 1, referred to as a “rate of change in viscosity after storage for 1 month at 40 “C”), and a result of the flowing-length by the storage stability evaluation examination (in Table 1, referred to as a “rate of change in flowing-length after storage of 40° C. for 1 month”) are shown in Table 1. Note that, in Tables 1 and 2, “(content of inorganic filler)/(content of curing agent)” has no unit, and other numerals have a unit “part by weight”. The unit “part by weight” indicates a content with respect to epoxy resin of 100 parts by weight.

TABLE 1

| | | Ex. 1 | Ex. 2 | Ex. 3 | Ex. 4 | Ex. 5 | Ex. 6 | Ex. 7 | Ex. 8 |
|---|---|---|---|---|---|---|---|---|---|
| epoxy | bisphenol-A diglycidyl ether | 100 | 100 | 100 | 100 | 100 | 100 | 100 | 100 |
| resin | | | | | | | | | |
| curing | modified alphatic polyamine compound | 20 | 8 | 6 | 20 | 20 | 5 | 4 | 20 |
| agent | 2-heptadecylimidazole | — | — | — | — | — | — | — | — |
| | epoxy resin amine adduct compound | — | — | — | — | — | — | — | — |
| in- | silica processed with long-chain alkyl | 0.5 | 8 | 1 | 5 | 0.4 | 6 | 2 | 10 |
| organic | (C8-20, average particle diameter: | | | | | | | | |
| filler | 10-50 nm) | | | | | | | | |
| | silica processed with long-chain alkyl | — | — | — | — | — | — | — | — |
| | (C6 or less, average particle diameter: | | | | | | | | |
| | 10-50 nm) | | | | | | | | |
| | silica processed with long-chain alkyl | — | — | — | — | — | — | — | — |
| | (C22 or more, average particle diameter: | | | | | | | | |
| | 10-50 nm) | | | | | | | | |
| | silica processed with long-chain alkyl | — | — | — | — | — | — | — | — |
| | (C8-20, average particle diameter: less | | | | | | | | |
| | than 10 nm) | | | | | | | | |
| | silica processed with long-chain alkyl | — | — | — | — | — | — | — | — |
| | (C8-20, average particle diameter: 100 nm | | | | | | | | |
| | or more) | | | | | | | | |
| | no surface treatment silica (average | — | — | — | — | — | — | — | — |
| | particle diameter: 10-50 nm) | | | | | | | | |
| storage | rate of change in viscosity after storage | excellent | excellent | excellent | excellent | good | good | good | good |
| stability | for 1 month at 40° C. | | | | | | | | |
| | rate of change in flowing-length after | excellent | excellent | excellent | excellent | good | good | good | good |
| | storage for 1 month at 40° C. | | | | | | | | |

| | | | | | | | | |
|---|---|---|---|---|---|---|---|---|
| (content of curing agent) + (content of inorganic | 20.5 | 16.0 | 7.0 | 25.0 | 20.4 | 11.0 | 6.0 | 30.0 |
| filler) | | | | | | | | |
| (content of inorganic filler)/(content of curing | 0.025 | 1.000 | 0.167 | 0.250 | 0.020 | 1.200 | 0.500 | 0.500 |
| agent) | | | | | | | | |

TABLE 2

| | | Ex. 9 | Ex. 10 | Ex. 11 | Ex. 12 | Co. Ex. 1 | Co. Ex. 2 | Co. Ex. 3 |
|---|---|---|---|---|---|---|---|---|
| epoxy | bisphenol-A diglycidyl ether | 100 | 100 | 100 | 100 | 100 | 100 | 100 |
| resin | | | | | | | | |
| curing | modified alphatic polyamine compound | 20 | 20 | 20 | 20 | — | — | 20 |
| agent | 2-heptadecylimidazole | — | — | — | — | 20 | — | — |
| | epoxy resin amine adduct compound | — | — | — | — | — | 20 | — |
| inorganic | silica processed with long-chain alkyl | — | — | — | — | 1 | 1 | — |
| filler | (C8-20, average particle diameter: | | | | | | | |
| | 10-50 nm) | | | | | | | |
| | silica processed with long-chain alkyl | 1 | — | — | — | — | — | — |
| | (C6 or less, average particle diameter: | | | | | | | |
| | 10-50 nm) | | | | | | | |
| | silica processed with long-chain alkyl | — | 1 | — | — | — | — | — |
| | (C22 or more, average particle | | | | | | | |
| | diameter: less than 10-50 nm) | | | | | | | |
| | silica processed with long-chain alkyl | — | — | 1 | — | — | — | — |
| | (C8-20, average particle diameter: less | | | | | | | |
| | than 10 nm) | | | | | | | |
| | silica processed with long-chain alkyl | — | — | — | 1 | — | — | — |
| | (C8-20, average particle diameter: 100 nm | | | | | | | |
| | or more) | | | | | | | |
| | no surface treatment silica (average | — | — | — | — | — | — | 1 |
| | particle diameter: 10-50 nm) | | | | | | | |
| storage | rate of change in viscosity after storage | good | good | good | good | poor | poor | poor |
| stability | for 1 month at 40° C. | | | | | | | |
| | rate of change in flowing-length after | good | good | good | good | poor | poor | poor |
| | storage for 1 month at 40° C. | | | | | | | |

| | | | | | | | |
|---|---|---|---|---|---|---|---|
| (content of curing agent) + (content of inorganic | 21.0 | 21.0 | 21.0 | 21.0 | 21.0 | 21.0 | 21.0 |
| filler) | | | | | | | |
| (content of inorganic filler)/(content of curing | 0.050 | 0.050 | 0.050 | 0.050 | 0.050 | 0.050 | 0.050 |
| agent) | | | | | | | |

### Examples 2 to 12

Examples 2 to 12 were prepared in the same way as Example 1, except that components described in Table 1 or Table 2 were mixed with each other in an introducing amount described in Table 1 or Table 2. The storage stability evaluation examination was performed on the one-pack type epoxy resin compositions thus obtained in terms of the viscosity and the flowing-length.

The contents of respective components, the sum total of the content of the modified aliphatic polyamine compound and the content of the inorganic filler treated with a long-chain hydrocarbon-group containing compound, the content of the inorganic filler treated with a long-chain hydrocarbon-group containing compound/the content of the modified aliphatic polyamine compound, results of the viscosity by the storage stability evaluation examination, and results of the flowing-length by the storage stability evaluation examination are shown in Table 1 and Table 2 in the same way as Example 1.

### Comparative Example 1

The one-pack type epoxy resin composition was prepared in the same way as Example 3, except that 2-heptadecylimidazole (C17Z, manufactured by SHIKOKU CHEMICALS CORPORATION) of 20 parts by weight was used as a curing agent, instead of the modified aliphatic polyamine compound of 6 parts by weight. The storage stability evaluation examination was performed on the one-pack type epoxy resin composition thus obtained in terms of the viscosity and the flowing-length. A result is shown in Table 2.

### Comparative Example 2

The one-pack type epoxy resin composition was prepared in the same way as Example 3, except that epoxy resin amine adduct compound (NOVACURE (registered trademark) HX-3721, manufactured by Asahi Kasei Corporation) of 20 parts by weight was used as a curing agent, instead of the modified aliphatic polyamine compound of 6 parts by weight. The storage stability evaluation examination was performed on the one-pack type epoxy resin composition thus obtained in terms of the viscosity and the flowing-length. A result is shown in Table 2.

### Comparative Example 3

The one-pack type epoxy resin composition was prepared in the same way as Example 1, except that 1 part by weight of silica which has not been a surface treatment is used as the inorganic filler, instead of 0.5 part by weight of silica which has been subjected to a surface treatment by a long-chain hydrocarbon group containing compound (C8 to C20, average particle diameter: 10 nm to 50 nm). The storage stability evaluation examination was performed on the one-pack type epoxy resin composition thus obtained in terms of the viscosity and the flowing-length. A result is shown in Table 2.

### INDUSTRIAL APPLICABILITY

As described above, a one-pack type epoxy resin composition according to the present invention is greatly usable because the one-pack type epoxy resin composition can be preferably used for performing airtight sealing or insulating sealing on gaps in various electronic or electric components such as a relay, a switch, and a sensor.

Therefore, the present invention can be used not only in a chemical industry field in which one-pack type epoxy resin compositions are manufactured, but also in a field relating to manufacturing of various electronic or electric components by use of the one-pack type epoxy resin compositions, and further in various manufacturing industry fields such as electric appliances, industrial machinery, vehicles, and railway vehicles in which the electronic or electric components are used.

### REFERENCE SIGNS LIST

1 metal terminal
2 molding material
3 one-pack type epoxy resin composition application surface
4 lower end (in which one-pack type epoxy resin composition finish to be flown) of trail

1. A one-pack type epoxy resin composition, containing, in an amount of 80 wt % or more:
(A) epoxy resin;
(B) a modified aliphatic polyamine compound; and
(C) inorganic filler treated with a long-chain hydrocarbon-group containing compound,
the (B) modified aliphatic polyamine compound serving as a curing agent, and the (C) inorganic filler treated with a long-chain hydrocarbon-group containing compound serving as inorganic filler, wherein
the modified aliphatic polyamine compound is a reaction product obtained by reacting (i) a dialkylaminoalkylamine compound, (ii) a cyclic amine compound containing, in a molecule, one or more nitrogen atoms each having an active hydrogen, and (iii) a diisocyanate compound or is a reaction product obtained by reacting the three components (i), (ii), and (iii) with (iv) and epoxy compound serving as a fourth component,
the long-chain hydrocarbon-group containing compound is a long-chain alkylsilane alkyl group containing compound which contains a hydrocarbon group having a main chain of C8 or more but C20 or less or is a saturated fatty acid which contains a hydrocarbon group having a main chain of C8 or more but C20 or less, and
in case where a content of the (A) epoxy resin is 100 parts by weight,
a sum total of the content of the (B) modified aliphatic polyamine compound and the content of the (C) inorganic filler treated with a long-chain hydrocarbon-group containing compound is 7 parts by weight or more but 25 parts by weight or less and
the content of the (C) inorganic filler treated with a long-chain hydrocarbon-group containing compound/the content of the (B) modified aliphatic polyamine compound is 0.025 or more but 1.000 or less.

2.-3. (canceled)

4. The one-pack type epoxy resin composition as set forth in claim 1,
wherein an average particle diameter of the inorganic filler treated with the long-chain hydrocarbon-group containing compound is 10 nm or more but 50 nm or less, the average particle diameter being measured by use of a particle size distribution measuring device based on a laser diffraction/scattering method (D50).

5. A component in which at least two members are adhered to each other by use of the one-pack type epoxy resin composition recited in claim 1.

6. A sealing method, comprising the step of
sealing an electronic or electric component by adhering at least two members to each other by use of the one-pack type epoxy resin composition recited in claim 1.
